(19) United States
(12) Patent Application Publication
(10) Pub. No.: US 2016/0086277 A1
(43) Pub. Date: Mar. 24, 2016

(54) Stochastic Dynamic Programming in a Computer Using a Multi-Part Utility Function and Local Search to Efficiently Compute Asset Allocation and Consumption

(71) Applicant: Gordon Raymond Irlam, Los Altos, CA (US)

(72) Inventor: Gordon Raymond Irlam, Los Altos, CA (US)

(21) Appl. No.: 14/493,115

(22) Filed: Sep. 22, 2014

(51) Int. Cl. G06Q 40/06

(52) U.S. Cl. CPC G06Q 40/06

(57) ABSTRACT

The invention relates, among other things, to methods and non-transitory computer-readable medium that include inputting data representing consumption levels into the memory, wherein a value of the consumption levels represents required consumption C₁, inputting data representing returns of each asset class into the memory, performing stochastic dynamic programming in the processors using the data representing the returns of each asset class and values of a utility function U based on the consumption levels to compute values of aggregate utility of wealth, storing the values of the aggregate utility of wealth in the memory, computing local searches in the processors of the values of aggregate utility of wealth over an asset allocation and consumption space to compute optimal asset allocation and optimal consumption, storing the optimal asset allocation and optimal consumption in the memory, and outputting the optimal asset allocation and the optimal consumption value for an initial age and wealth.

### BACKGROUND

The invention relates to improvements in computer technology.

Asset allocation is the division of financial resources between asset classes (e.g., stocks/bonds) in order to meet financial goals. Consumption is the amount of money spent. The asset allocation and consumption problem is deciding how much wealth to consume annually and how and how much to invest for the future in order to meet goals.

The Retirement Industry Investment Association (RIIA) recommends a floor plus upside approach to retirement investing. First, an income floor should be established using Single Premium Immediate Annuities (SPIAs), a TIPS bond ladder, or other low risk assets to cover non-discretionary expenses. Then riskier assets such as equities should be added to cover discretionary expenses. The adoption of the floor plus upside approach, in a sense, puts the solution before the problem. The problem should be how to maximize retirement well-being when consumption utility is split into separate floor and upside utility functions.

### SUMMARY OF THE INVENTION

The invention relates in a feature to a method in a computer including processor(s) coupled to a memory, including the steps of:
inputting data representing consumption level(s) into the memory, wherein a value of the consumption level(s) represents required consumption C₁;
inputting data representing returns of each asset class into the memory;
performing one or more step(s) of stochastic dynamic programming (SDP) in the processor(s) using the data representing the returns of each asset class and values of a utility function U based on the consumption levels to compute values of aggregate utility of wealth, wherein the SDP step(s) includes the following sub-steps:
   reading data representing an aggregate utility of wealth Uₜ₊₁ for wealth levels W_{t+1,1} through W_{t+1,M}, and a description of single time period utility U;
   computing local searches in the processor(s) an optimal asset allocation vector Aₜ, an optimal consumption Cₜ, and an optimal aggregate utility of wealth Uₜ for a wealth level W_{t,1};
   computing local searches in the processor(s) the optimal asset allocation vector Aₜ, the optimal consumption Cₜ, and the optimal aggregate utility of wealth Uₜ for a wealth level W_{t,2};
   computing local searches in the processor(s) the optimal asset allocation vector Aₜ, the optimal consumption Cₜ, and the optimal aggregate utility of wealth Uₜ for additional wealth levels up to at least wealth level W_{t,M};
   storing the values of the aggregate utility of wealth Uₜ for wealth levels W_{t,1} through W_{t,M} in the memory; and
outputting the optimal asset allocation vector A_{B} and the optimal consumption C_{B} at an initial age B and wealth W_{B}.

### BRIEF DESCRIPTION OF THE DRAWINGS

FIG. 1 illustrates a computer for implementing the methods of the invention.

FIG. 2A illustrates utility as a function of consumption.

FIG. 2B illustrates the derivative of the utility curves of FIG. 2A.

FIG. 3A illustrates a two part utility function without a transition region.

FIG. 3B illustrates the derivative of the two part utility function without a transition region of FIG. 3A.

FIG. 4A illustrates a two part utility function with a transition region.

FIG. 4B illustrates the derivative of the two part utility function with a transition region of FIG. 4A.

FIGS. 5A-5D illustrates stochastic dynamic programming for asset allocation and consumption.

FIG. 6 is a flow chart that illustrates a method of stochastic dynamic programming to plan asset allocation and consumption.

FIG. 7 is a flow chart that illustrates additional steps of the method of stochastic dynamic programming illustrated in FIG. 6.

FIG. 8 is a flow chart that illustrates additional steps of the method of stochastic dynamic programming illustrated in FIG. 7.

FIG. 9 illustrates the computation of U_{J}(C).

FIG. 10 illustrates the computation of utility U as a function of consumption C.

FIG. 11 illustrates a Monte Carlo simulation of the portfolio size as a function of investor's age.

FIG. 12 illustrates optimal percent stock allocation vs. investor age and portfolio size.

FIG. 13 illustrates stock/bond allocation vs. portfolio size at a particular investor age.

FIG. 14 illustrates consumption paths vs. investor age obtained by Monte Carlo simulation.

FIG. 15 illustrates confidence bounds on consumption vs. investor age.

FIG. 16 illustrates probability distribution of change in annual consumption.

FIG. 17 illustrates probability distribution of annual change in portfolio size.

FIG. 18 illustrates confidence bounds on portfolio size vs. investor age.

FIG. 19 illustrates a utility slope vs. consumption curve.

FIG. 20 illustrates an absolute risk aversion vs. consumption.

FIG. 21 illustrates confidence bounds on consumption vs. investor age for an upside discount rate of 15%.

### DETAILED DESCRIPTION OF THE PREFERRED EMBODIMENTS

The following description includes the best mode of carrying out the invention. The detailed description illustrates the principles of the invention and should not be taken in a limiting sense. The scope of the invention is determined by reference to the claims. Each part (or step) is assigned its own part (or step) number throughout the specification and drawings. The punctuation mark ‘and apostrophe ' mean prime wherever they appear in the drawings and specification.

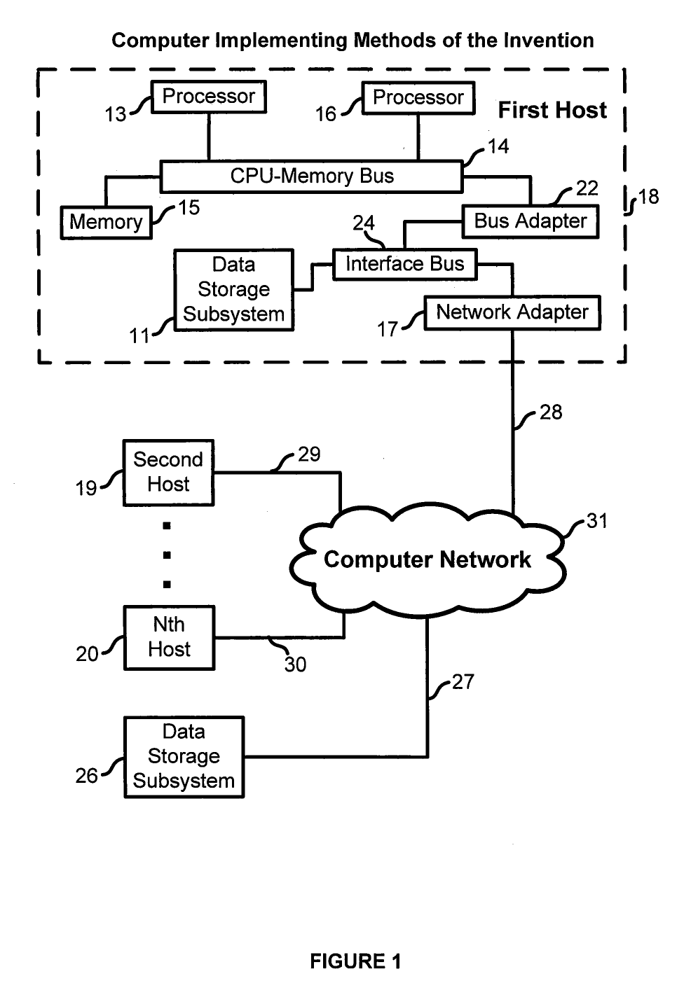

FIG. 1 illustrates a cluster of hosts that can execute the methods in software as described below. Each host is a computer that can communicate with data storage subsystems 11 and 26 (e.g., a disk array and/or solid state memory) and with each other. Hennessy and Patterson, Computer Architecture: A Quantitative Approach (2012), and Patterson and Hennessy, Computer Organization and Design: The Hardware/Software Interface (2013) describe computer hardware and software, storage systems, caching, and networks and are incorporated by reference.

As shown in FIG. 1, a first host 18, which is representative of the second host 19 through Nth host 20, includes a motherboard with a CPU-memory bus 14 that communicates with dual processors 13 and 16. The processor used is not essential to the invention and could be any suitable processor such as the Intel Pentium processor. A processor could be any suitable general purpose processor running software, an ASIC dedicated to perform the operations described herein or a field programmable gate array (FPGA). Also, one could implement the invention using a single processor in each host or more than two processors to meet various performance requirements. The arrangement of the processors is not essential to the invention. Data is defined as including user data, instructions, and metadata. Inputting data is defined as the input of parameters and data from user input, computer memory, and/or storage device(s). The processor reads and writes data to memory 15 and/or data storage subsystem 11 and 26. Each host includes a bus adapter 22 between the CPU-memory bus 14 and an interface bus 24. A non-transitory computer-readable medium (e.g., storage device, CD, DVD, floppy disk, USB storage device) can be used to encode the software program instructions described in the methods below.

Each host runs an operating system such as the Apple OS, Linux, UNIX, a Windows OS, or another suitable operating system. Tanenbaum et al., Modern Operating Systems (2014) describes operating systems in detail and is incorporated by reference herein. Bovet and Cesati, Understanding the Linux Kernel (2005), describe operating systems in detail and is incorporated by reference herein.

The first host 18 communicates through the network adapter 17 over a link 28 with a computer network 31 with other hosts. Similarly, the second host 19 communicates over link 29 with the computer network 31, and the Nth host 20 communicates over link 30 with the computer network 31. In sum, the hosts 18, 19 and 20 communicate with each other and with the computer network 31. A data storage subsystem 26 communicates over link 27 with computer network 31. The link 27, the link 29, the link 30, and the computer network 31 can be implemented using a bus, SAN, LAN, or WAN technology such as Fibre Channel, SCSI, InfiniBand, or Ethernet.

Utility is a number that represents the value of consumption (i.e., spending) to an individual. For example, the utility of consuming $100K per year might be represented by 100,000 and $1M per year might be 400,000. Thus, utility is usually not a linear function of consumption. The utility for one individual to consume another increment of money may be different than another individual.

In an embodiment, the method uses constant relative risk aversion (CRRA) utility functions of the form U=(1/(1−γ))*C^{1-γ} where C=consumption, U=utility, and γ is the coefficient of relative risk aversion. When γ=1, U=log(C).

With a CRRA utility function, an individual is neutral to a 50/50 chance of 100% consumption or 200% consumption, or a guaranteed ((1+2^{1-γ})/2)^{1/(1-γ)} consumption. A γ of 4 corresponds to a neutral trade-off of a 50/50 chance for 100% or 200% consumption and a guaranteed 121% consumption. An incremental dollar at 50% consumption would be worth giving up 2^{γ} incremental dollars at 100% consumption. With a γ of 4, a dollar at 50% consumption would be worth giving up 16 incremental dollars at 100% consumption.

Dohmen, Individual risk attitudes: new evidence from a large, representative, experimentally-validated survey, IZA Discussion Papers, No. 1730 (2005) presents experimental evidence that the median value for γ lies somewhere in the range of 3-5.

A low γ will favor stocks, and a high γ will favor bonds.

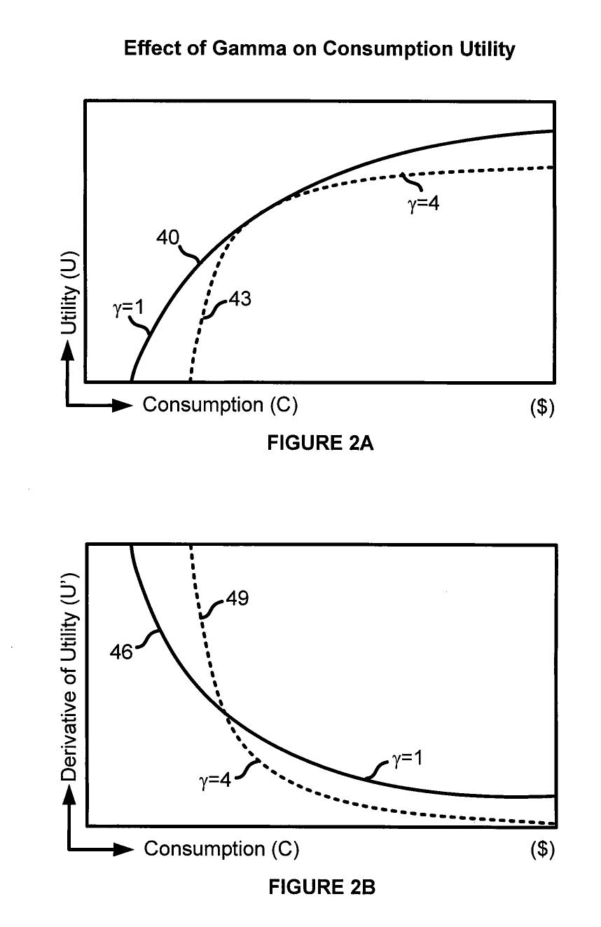

Constant relative risk aversion (CRRA) is one possible curve of utility vs. consumption. FIG. 2A illustrates the utility (U) of consumption (C) (e.g., US dollars spent) for CRRA utility functions with different coefficients of relative risk aversion. A coefficient of relative risk aversion (γ) having a high value indicates less willingness to take risks for investment gains. Solid line curve 40 has a lower coefficient of relative risk aversion (e.g., γ=1), while the dotted line curve 43 has a higher coefficient of relative risk aversion (e.g., γ=4). Initially, utility curve 43 increases faster than utility curve 40, then it increases more slowly at higher levels of consumption. Thus, in both curves, the utility increases but is not linear (i.e., flattens) as consumption increases. The coefficient of relative risk aversion will affect the utility of consumption.

FIG. 2B illustrates the derivative of the utility (U′) of consumption curve shown in FIG. 2A. U′ indicates the marginal benefit of an incremental unit of consumption. The marginal benefit of consuming one dollar might be 0.5 when C=$100K. Solid line curve 46 has a lower coefficient of relative risk aversion (e.g., γ=1), while the dotted line curve 49 has a higher coefficient of relative risk aversion (e.g., γ=4).

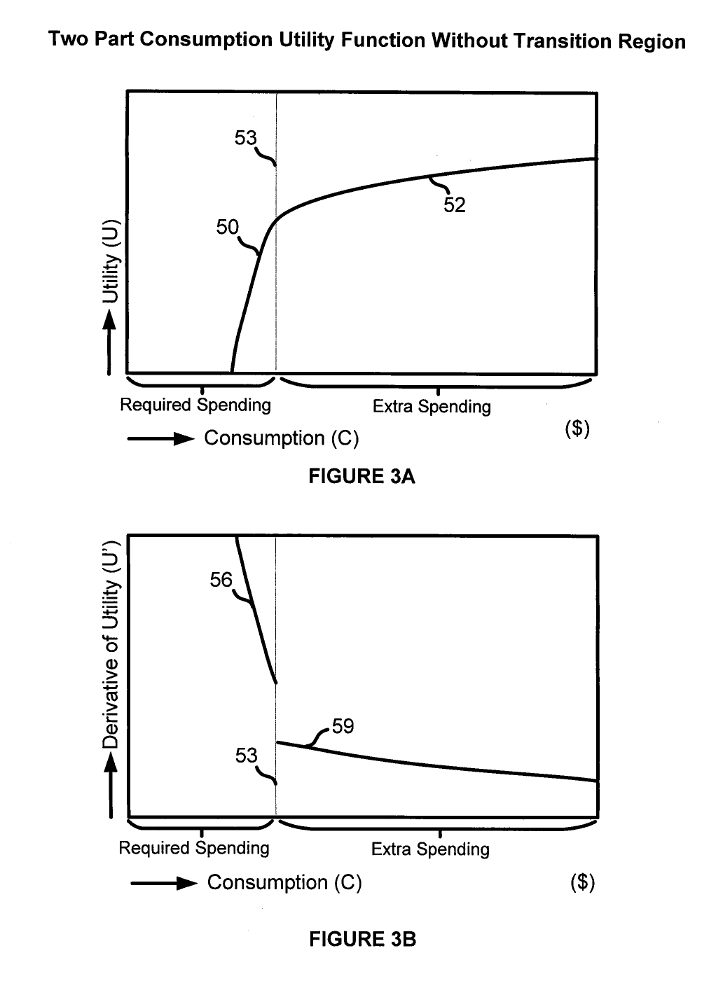

FIG. 3A illustrates a two part utility function without a transition region. In an embodiment, the utility function is composed of two parts. Required spending forms the first part, and in an embodiment corresponds to non-discretionary spending (e.g., food, clothes, shelter). Extra spending forms the second part, and in an embodiment corresponds to discretionary spending (e.g., luxury goods and services, entertainment, vacations, charitable gifts). In another aspect of FIG. 3A, the dotted line 53 is the upper limit of the required spending region and the lower limit of the extra spending region. In the required spending region, a risk averse utility function 50 is the first part and determines the utility of consumption. In an embodiment, the risk averse utility function is based on a higher coefficient of relative risk aversion (e.g., γ=4). In an alternative embodiment, the risk averse utility function is based on exponential utility function such as 1−e^{-αC}/α. The variable α is a constant that represents the degree of risk aversion. In the extra spending region, a higher risk utility function 52 is the second part and determines the utility of consumption. In an embodiment, the higher risk utility function is based on a lower CRRA (e.g., γ=1). In an alternative embodiment, the higher risk utility function is based on exponential utility function such as 1−e^{-αC}/α.

FIG. 3B illustrates the derivative of the two part utility function without a transition region of FIG. 3A. As shown, the curve 56 is the derivative of utility curve 50, and rapidly decreases as consumption increases until it reaches the required spending level 53 where it is discontinuous and shifts to a slowly decreasing derivative curve 59.

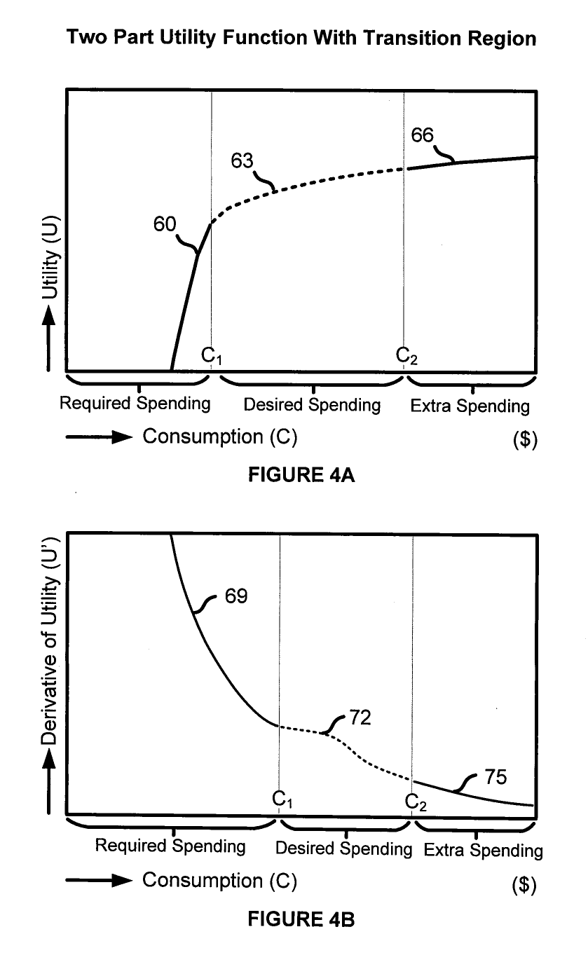

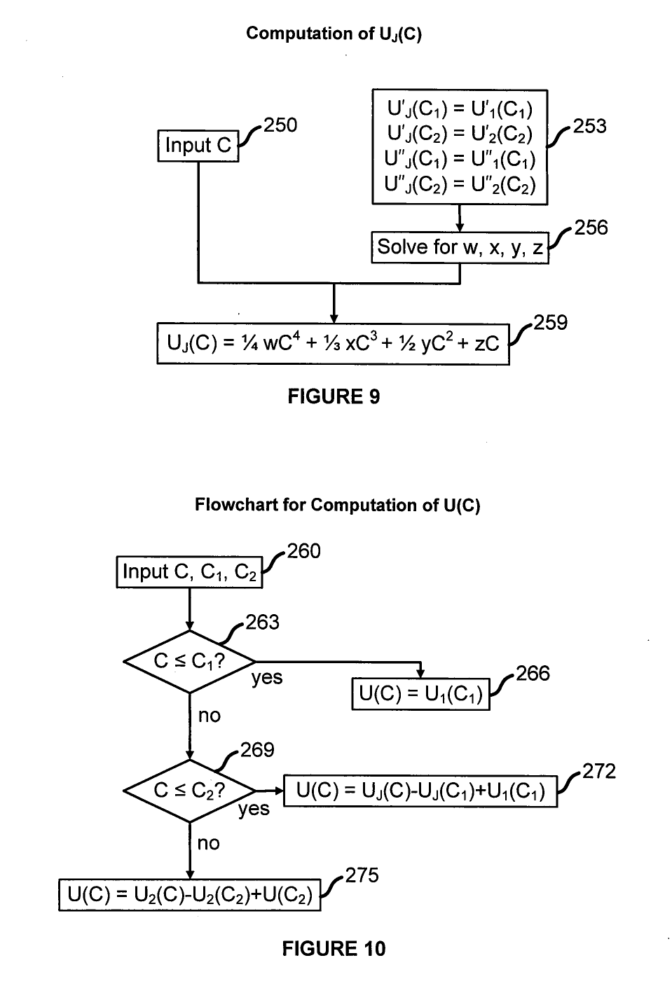

FIG. 4A illustrates a two part utility function with a transition region. In another embodiment, the utility function is composed of two parts and a transition region. Required spending forms the first part, and in an embodiment corresponds to non-discretionary spending (e.g., food, clothes, and shelter). Desired spending forms the transition region, and in an embodiment corresponds to discretionary spending where there is a direct benefit (e.g., luxury goods and services, entertainment, vacations). Extra spending forms the second part of the utility function, and in an embodiment corresponds to discretionary spending where there is no direct benefit (e.g., charitable gifts). In another aspect of FIG. 4A, the utility curve has three segments. The first segment is a utility curve 60 in the required spending region. Utility increases rapidly with respect to consumption in the required spending range ending at consumption level C₁. In an embodiment, the utility curve 60 has γ=4. The second segment is a utility curve 63 which encompasses the transition region covering desired spending (e.g., spending on going out to eat or to a movie) between consumption levels C₁ and C₂. The transition region isn't a CRRA utility function, and so it doesn't have a γ. Instead, in an embodiment, it is defined as a cubic polynomial curve that joins the two regions in utility slope space. In an embodiment, a factor of 20 is defined as the ratio between the slope of the required and extra spending region utility functions at the start of the transition region. This indicates that required spending is considered far more important than extra spending. FIG. 9 illustrates a method of computing the second segment of the utility curve. Referring to FIG. 4A, the third segment is utility curve 66 in the extra spending region (e.g., charitable donations) above consumption level C₂. In an embodiment utility curve 66 has γ=1 and slowly increases with increase in consumption.

Referring to FIGS. 3A and 4A, it should be recognized that even though a particular spending level may be described as required, there is no guarantee that the spending level will be attained (e.g., the initial portfolio is too small to support the required spending level).

FIG. 4B illustrates the derivative of a two part utility function with the transition region shown in FIG. 4A. In an embodiment, the method computes a utility curve 72 that smoothly connects utility curves 69 and 75.

In a feature, the methods use stochastic dynamic programming (SDP) to concurrently solve the asset allocation and consumption problem. For example, the method may determine the optimal stock/bond asset allocation and consumption decisions for a two-part utility function that is representative of a retired couple's need for an income floor and desire for upside potential without using annuities.

SDP is a technique that can compute optimal asset allocation and consumption strategies. SDP is a form of backwards induction. In an embodiment, a simplifying assumption is that asset class returns are independent over time. For details on SDP, see Bellman, Bottleneck problems and dynamic programming, Proceedings of the National Academy of Sciences of the USA, 39(9), pages 947-951 (1953), Mulvey et al., Stochastic network optimization models for investment planning, Annals of Operations Research, 20(1), pages 187-217 (1989), and Wikipedia Stochastic Programming (2014), which are all incorporated by reference.

In an embodiment, the invention seeks to maximize the expected value of U_{B}(W_{B}) where:

B is the initial age

Wₜ is wealth (portfolio size) at age t

Uₜ(Wₜ) represents the aggregate utility of wealth Wₜ at age t

Uₜ(Wₜ)=aₜU(Cₜ(Wₜ))/(1+r)^{t}+Eₜ[Uₜ₊₁(Wₜ₊₁)] for t<N

U_{N}(W_{N})=0

Wₜ₊₁=(Wₜ−Cₜ(Wₜ))Aₜ(Wₜ)·(1+Xₜ)

U(Cₜ(Wₜ)) represents the single time period utility of consumption Cₜ(Wₜ), described by a two part utility function or otherwise

Cₜ(Wₜ) is the consumption amount for level Wₜ at age t

r represents the discount rate

aₜ represents the unconditional probability of being alive at age t

Eₜ is the conditional expectation operator at age t (conditional on the realized values X_{B}, . . . Xₜ)

N is an upper bound on age

Aₜ(Wₜ) is the asset allocation vector for level Wₜ at age t

· is the vector dot product operator

1 is the vector of 1's

Xₜ is the stochastic term describing returns on the asset classes at age t

If Xₜ is time-wise independent, Eₜ becomes the unconditional expectation operator at age t, and through a process of backwards induction SDP yields the optimal asset allocation and consumption maps Aₜ(Wₜ) and Cₜ(Wₜ).

The process of backwards induction involves for a given age and wealth level, at least notionally, trying each asset allocation and consumption possibility and finding the expected value of Uₜ₊₁(Wₜ₊₁) evaluated over each returns possibility.

The term aₜU(Cₜ(Wₜ))/(1+r)^{t} can be generalized by using different utility functions or discount rates over time, so that the whole term is a function of age and consumption or even wealth. An example of this is to split U into multiple parts and use different discount rates over time and as a function of consumption. Splitting U into two parts at consumption level L, a floor utility, U_{F}, with discount rate r_{F}, and an upside utility, U_{P}, with a discount rate r_{P}, gives:

aₜU_{F}(Cₜ(Wₜ))/(1+r_{F})^{t}+aₜU_{P}(Cₜ(Wₜ))/(1+r_{P})^{t}

where:

U_{F}(C)=U(C) for C≦L

U_{F}(C)=U(L) for C>L

U_{P}(C)=0 for C<L

U_{P}(C)=U(C)−U(L) for C>L

If U′ is split into multiple parts defined by polynomial join points or spline knots it will be appreciated that the consumption levels defining these parts may, but need not, correspond to the polynomial join points or spline knots of U′.

Using Epstein-Zin or recursive utility is another possibility. For this case we have separate risk and time aggregator functions, Rₜ and Tₜ, and we have:

Uₜ(Wₜ)=Tₜ(Wₜ, Rₜ₊₁⁻¹(Eₜ[Rₜ₊₁(Uₜ₊₁(Wₜ₊₁))]))

Commonly with recursive utility the first parameter of Tₜ is given as consumption rather than wealth. In the original scenario:

Rₜ(u)=u

Tₜ(Wₜ, u)=aₜU(Cₜ(Wₜ))/(1+r)^{t}+u

With recursive utility, setting:

Tₜ(Wₜ, u)=u for t<retirement age

allows us to compute the optimal pre and post retirement strategy when all that matters is retirement consumption.

More generally Wₜ evolves according to:

Wₜ₊₁=Sₜ(Wₜ, Xₜ)

for wealth transition function Sₜ

Modifying the original scenario and setting Wₜ₊₁=(Wₜ−Cₜ(Wₜ))·Aₜ(Wₜ)·(1+Xₜ)+Iₜ where Iₜ is the exogenous change in the portfolio size at age t, allows us to handle non-consumption portfolio contributions and withdrawals, such as pre-retirement retirement savings contributions.

In the general case Wₜ may be a vector and there may be additional elements to Xₜ. This makes it possible to handle other forms of wealth, such as IRAs, nominal or inflation indexed annuities, or human capital.

It is impossible to compute the optimal asset allocation and consumption for every possible wealth value. Instead the method computes at a fixed set of values, and interpolates between the points. In an embodiment, the method uses cubic spline interpolation. Also, the method can interpolate on an exponentially increasing set of values which gives better performance than on a linear scale.

To get a handle on the impact of a stochastic lifespan, the method follows the approach of Finke et al., Spending flexibility and safe withdrawal rates, Journal of Financial Planning, 25(3), 44-51 (2012), which is incorporated by reference, and uses actuarial data directly. The probabilities of being alive are combined with the year-by-year utility values to compute the overall utility. This weighted average is calculated without the use of randomly drawn ages of death or other Monte Carlo techniques.

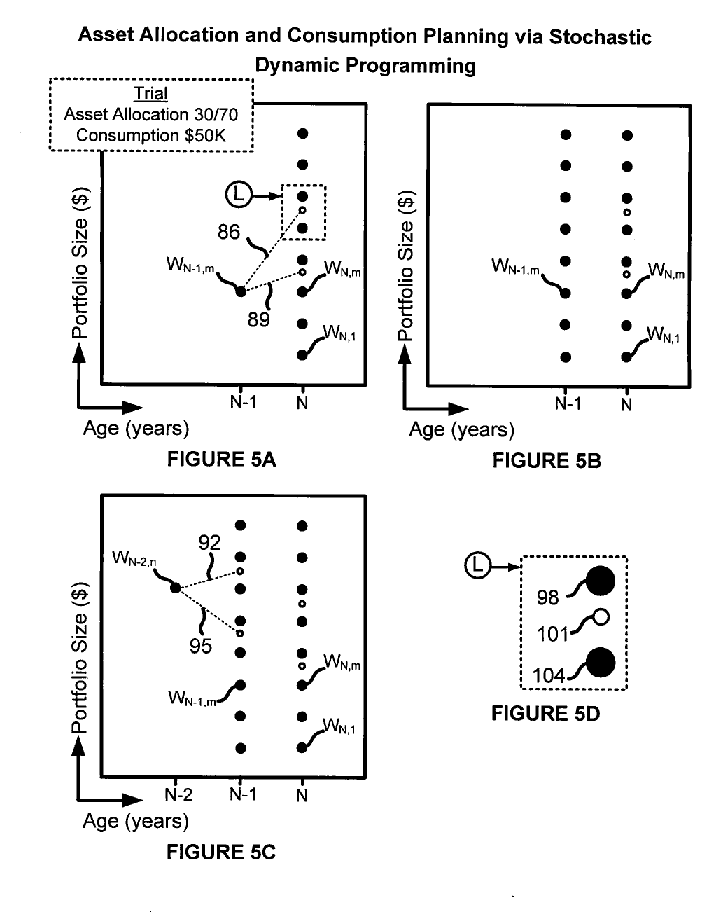

FIGS. 5A-5D illustrates the overall flow of stochastic dynamic programming (SDP) for asset allocation and consumption. FIGS. 5A-5D illustrate that SDP is implemented using portfolio size (e.g., US dollars) as a function of a person's age (e.g., years).

FIG. 5A shows computation of the optimal asset allocation, consumption, and aggregate utility of wealth values for wealth level W_{N-1,m}. This is performed by calculating the results for a number of asset allocation and consumption possibilities (e.g., 30/70 stock/bond and $50K consumption) and determining the best values. When determining the best values for age N−1, the method uses the best values computed for age N. When computing the optimal strategy for wealth level W_{N-1,m}, the method will compute the performance of the portfolio under a variety of different return possibilities as shown by path 86 and path 89. Also referring to FIG. 5D, box L shows the value at point 101 for the path 86 that falls between previously computed points 98 and 104. The method interpolates the value at point 101 using the relative distance between point 101 and points 98 and 104.

FIG. 5B shows that after computing the optimal strategy for wealth level W_{N-1,m} in FIG. 5A, the method can similarly compute the optimal strategy for a sequence of portfolio sizes represented by the points in a vertical line at age N−1.

FIG. 5C shows that the method then steps back a year (e.g., N−2) and starts to compute the optimal strategy for the wealth level W_{N-2,n}.

The method computes the optimal strategy of FIGS. 5A-5D by stepping back an increment of time (e.g., a year) to an initial age B.

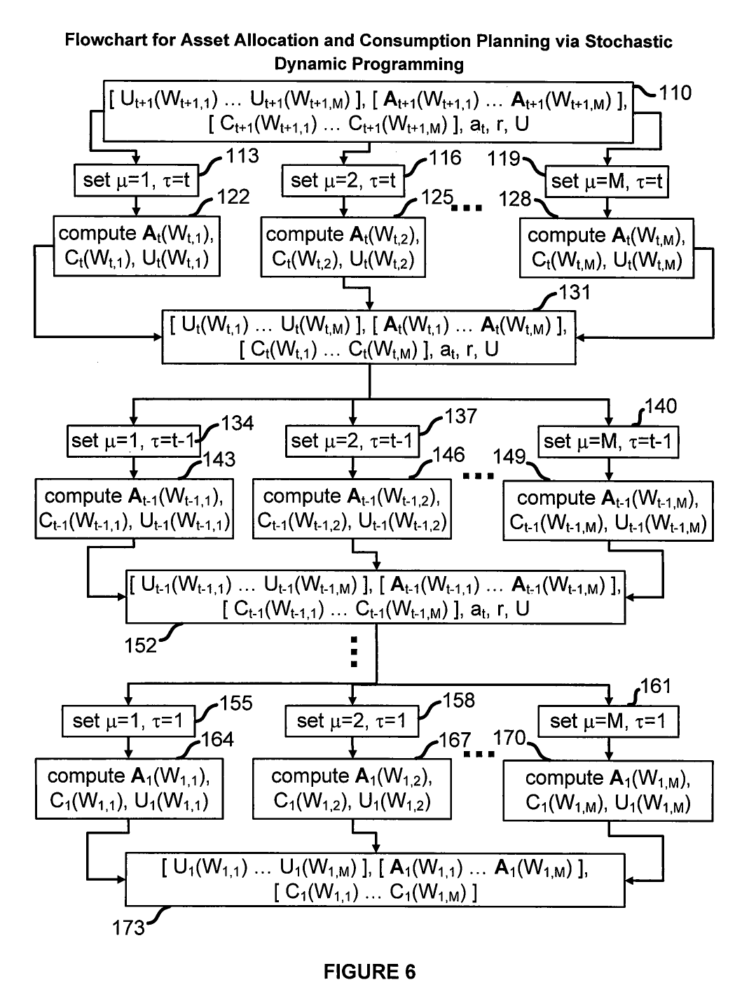

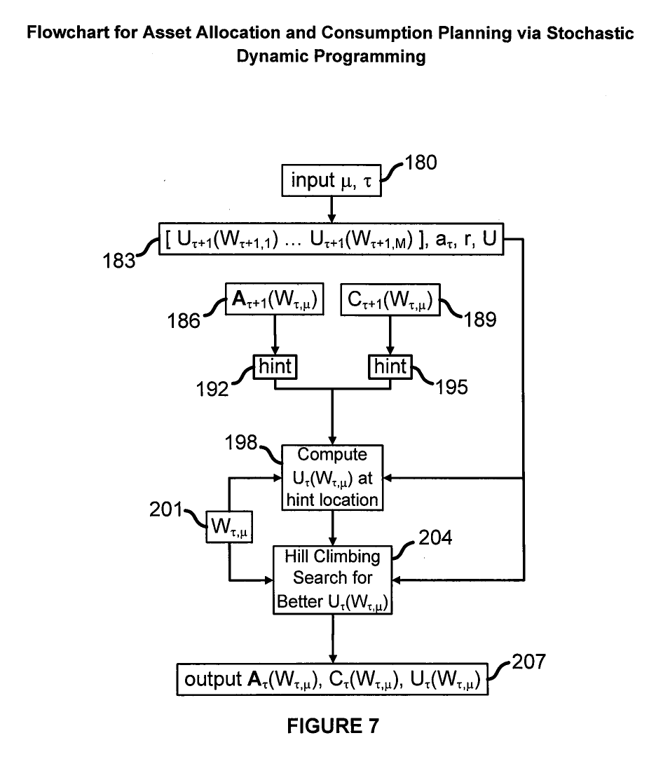

FIG. 6 illustrates certain details of the method to determine optimal asset allocation and consumption. At step 110, the method receives input values for the aggregate utility of wealth Uₜ₊₁, asset allocation vector Aₜ₊₁, and consumption amount Cₜ₊₁ for wealth levels W_{t+1,1} through W_{t+1,M}, as well as a probability of being alive aₜ, a discount rate r, and a description of single time period utility U. At step 113, the method sets μ=1 and τ=t and at step 122 (FIG. 7) computes the optimal asset allocation vector Aₜ, the consumption amount Cₜ, and the aggregate utility of wealth Uₜ for the wealth level W_{t,1}. At step 116, the method sets μ=2 and τ=t and at step 125 (FIG. 7) computes the optimal asset allocation vector Aₜ, the consumption amount Cₜ, and the aggregate utility of wealth Uₜ for the wealth level W_{t,2}. This computation is repeated until at step 119, the method sets μ=M and τ=t and at step 128 (FIG. 7) computes the optimal asset allocation vector Aₜ, the consumption amount Cₜ, and the aggregate utility of wealth Uₜ for the wealth level W_{t,M}. At step 131, the method stores the results from steps 122, 125 . . . 128 in a computer memory (FIG. 1).

At steps 134, 137, and 140, the method sets μ=1, μ=2 . . . μ=M, respectively, while τ=t−1, then proceeds to steps 143, 146 . . . 149 (FIG. 7), respectively, where the method computes the optimal asset allocation vector Aₜ₋₁, the consumption amount Cₜ₋₁, and the aggregate utility of wealth Uₜ₋₁ for the wealth levels W_{t-1,1}, W_{t-1,2} . . . W_{t-1,M}, respectively. At step 152, the method stores the results from steps 143, 146 . . . 149 in a computer memory (FIG. 1).

The method is repeated for each value of ti until the method proceeds to steps 155, 158, and 161, the method sets μ=1, μ=2 . . . μ=M, respectively, while τ=t, then proceeds to steps 164, 167 . . . 170 (FIG. 7), respectively, where the method computes the optimal asset allocation vector A₁, the consumption amount C₁, and the aggregate utility of wealth U₁ for the wealth levels W_{1,1}, W_{1,2} . . . W_{1,M}, respectively. At step 173, the method stores the results from steps 164, 167 . . . 170 in a computer memory (FIG. 1).

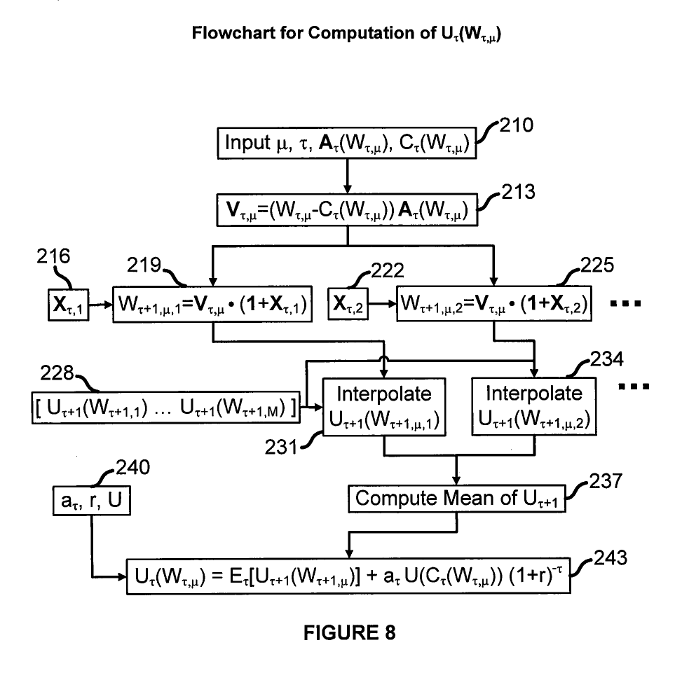

FIG. 7 is a flow chart that illustrates additional steps of the method of stochastic dynamic programming illustrated in FIG. 6. At step 180, the method receives input values for μ and τ. At step 183, the method receives input values for the aggregate utility of wealth U_{τ+1} for wealth levels W_{τ+1,1} through W_{τ+1,M}, as well as a probability of being alive a_{τ}, a discount rate r, and a description of single time period utility U. At step 186, the method reads from computer memory values for optimal asset allocation vector A_{τ+1}(W_{τ,μ}). At step 189, the method reads from computer memory values for consumption amount C_{τ+1}(W_{τ,μ}). At steps 192 and 195, the method uses the values obtained at steps 186 and 189, respectively, as hint locations. At step 198, the method computes U_{τ}(W_{τ,μ}) at the hint locations (FIG. 8 gives further details of the method of step 198). At step 201, the method receives an input value for W_{τ,μ}. At step 204, the method performs the local search (e.g., hill climbing) over asset allocation and consumption values for a higher value of U_{τ}(W_{τ,μ}) (FIG. 8 illustrates how to determine the height of the hill at a given location). At step 207, the method outputs the values of the optimal asset allocation vector Aₜ, the consumption amount C_{τ}, and the aggregate utility of wealth U_{τ} for the wealth level W_{τ,μ}, which are the input values for steps 131, 152 . . . 173 as shown in FIG. 6.

In Patterson and Hennessy, Computer organization and Design: The Hardware/Software Interface (2013) computer performance on a desktop computer is primarily defined as 1 divided by the response time (i.e., execution time), while in a data center, throughput, defined as the number of tasks completed per unit of time, is an important measure of computer performance.

The method generates optimal asset allocation and consumption values. One way of doing this is to perform an exhaustive search of all asset allocation and consumption values for each age and wealth level. This would require assessing the performance of a large number of asset allocation and consumption possibilities (e.g., for 2 asset classes: 100 asset allocations×1,000 consumption possibilities×50 ages×200 wealth levels=1 billion possibilities), each of which has to be evaluated against a number of return possibilities (e.g., for 1927−2013=87 yearly returns). Evaluating each return possibility requires executing a number of machine instructions (e.g., 2,000 instructions per return possibility). Thus, using an exhaustive search would take many machine instructions (e.g., 174 trillion), which would take a long time even on a fast computer (e.g., 18 minutes for a 32-core machine executing 5 billion instruction per second per core). Computer performance would thus be low, both for a desktop computer with a single user and in a data center computing the optimal strategy for many investors. For more than 2 asset classes, performance would be very low (e.g., the 32-core computer taking 30 hours to compute 3 asset classes, and 125 days for 4 asset classes).

The method solves the problem of inefficient computer performance by making use of local search (e.g. hill climbing, simulated annealing). Local search is more complicated to implement, but reduces the number of possibilities to be evaluated significantly (e.g. from 1 billion or more down to 500,000). The Wikipedia articles, Hill Climbing (2014), and Local Search (optimization) (2014) which are both incorporated by reference herein, describe hill climbing search and local search in detail. One part of the difficulty in implementing hill climbing is that asset allocation is a vector while consumption is a scalar quantity. In an embodiment they are combined into a single vector quantity to be searched over. A second difficulty stems from the constraint that the sums of the asset allocations must always equal 100%. This prevents independently walking along a given asset allocation dimension. In an embodiment, the other asset allocation dimensions are proportionately scaled back when one asset allocation dimension is increased. A third difficulty is in implementing the differing bounds on asset allocation and consumption. In an embodiment the range of possible valid consumption values is mapped onto the interval 0 to 100%, so that all dimensions may be treated equally. A fourth difficulty lies in the size of steps and the termination condition, in which a small step for asset allocation, may not be of the same size as a small step for consumption. In an embodiment, separate step sizes are maintained for each dimension.

In an embodiment, the computer executes a round robin one dimension in turn hill climbing search. This gives good performance (e.g. 1 second on a 32 core machine), however, as the number of asset classes increases it may get stuck on ridges. When hill climbing, a hint is used to try and start the search in the vicinity of the solution. For the hint an embodiment uses the optimal asset allocation and consumption found for the same portfolio size and one time period older. This reduces the time taken by hill climbing.

Getting stuck on ridges is a known problem of hill climbing. In an embodiment the method uses a local search that is able to walk on ridges, such as described in Yuret, D., How to Walk on Ridges, From Genetic Algorithms To Efficient Optimization, Massachusetts Institute of Technology: Artificial Intelligence Laboratory, A.I. Technical Report No. 1569 (1994), which is incorporated by reference. In an alternative embodiment, the method reduces the asset allocation dimensions being searched down to a single dimension by pre-computing an asset allocation frontier using mean-variance optimization as described in Markowitz, Portfolio Selection, The Journal of Finance, 7:1, 77-91 (1952), which is incorporated by reference, or full scale optimization, then performs local search (e.g., hill climbing) on the single asset allocation frontier dimension and consumption dimension. The efficient frontier produced using mean-variance optimization is known to be optimal if the returns are normally distributed. Full scale optimization involves considering the results of each possible asset allocation, and from that determining the asset allocation frontier. Full scale optimization is more computationally intensive, but does not require the returns be normally distributed.

After reducing the number of asset allocation dimensions (e.g., mean-variance optimization, full scale optimization), the use of local search (e.g., hill climbing, or a local search that is able to walk on ridges) improves the performance of the computer significantly (e.g., by a factor of 2,000).

FIG. 8 is a flow chart that illustrates additional steps of the method of stochastic dynamic programming illustrated in FIG. 7. At step 210, the method receives as input μ, τ, and candidate values for A_{τ}(W_{τ,μ}), C_{τ}(W_{τ,μ}). At step 213, the method computes the asset level vector: V_{τ,μ}=(W_{τ,μ}−C_{τ}(W_{τ,μ}))A_{τ}(W_{τ,μ}). At step 216, the method receives as an input a stochastic term X_{τ,1} describing possible asset class returns. At step 219, the method computes W_{τ+1,μ,1}=V_{τ,μ}·(1+X_{τ,1}). At step 222, the method receives as an input, a stochastic term X_{t,2} describing possible asset class returns. At step 225, the method computes W_{τ+1,μ,2}=V_{τ,μ}·(1+X_{τ,2}). In the equations computed in steps 219 and 225, the non-subscripted symbol “1” denotes a vector of 1's and the symbol “·” denotes the vector dot product operator.

As shown, the method repeats for additional stochastic terms as indicated by “ . . . ”. At step 228, the method receives input values for the aggregate utility of wealth U_{τ,1} for wealth levels W_{τ+1,1} through W_{τ+1,M}. At step 231, the method interpolates the value of U_{τ+1} at wealth level W_{τ+1,μ,1}. At step 234, the method interpolates the value of U_{τ+1} at wealth level W_{τ+1,μ2}. The method repeats for additional terms as indicated by “ . . . ”. At step 237, the method computes the mean of U_{τ+1}. At step 240, the method receives as inputs a probability of being alive a_{τ}, a discount rate r, and a description of single time period utility U. At step 243, the method computes the aggregate utility of wealth: U_{τ}(W_{τ,μ})=E_{τ}[U_{τ+1}(W_{τ+1,μ})]+a_{τ}U(C_{τ}(W_{τ,μ}))(1+r)^{-τ}.

FIG. 9 illustrates the computation of U_{J}(C). For consumption join points C₁ and C₂, to construct a cubic polynomial U_{J}′ that joins the two utility functions U₁ and U₂ in U′ space, we have:

U_{J}′(C)=wC³+xC²+yC+z

U_{J}″(C)=3wC²+2xC+y

At step 253, the method uses the following join constraints:

U_{J}′(C₁)=U₁′(C₁)

U_{J}′(C₂)=U₂′(C₂)

U_{J}″(C₁)=U₁″(C₁)

U_{J}″(C₂)=U₂″(C₂)

This produces a system of four linear equations in four unknowns, w, x, y, and z, and can be solved using standard linear algebra techniques. Thus, at step 256, the method solves for w, x, y, and z, which are the coefficients of the polynomial that will define the curve in the transition region.

At step 250, the method will receive as an input consumption C. At step 259, the method will compute U_{J}:

U_{J}(C)=¼wC⁴+⅓xC³+½yC²+zC

FIG. 10 illustrates computing a utility U(C) that is continuous at C₁ and C₂. At step 260, the method receives C, C₁, and C₂ as inputs. At step 263, the method checks if C≦C₁. If so, at step 266, the method computes U(C)=U₁(C). If not, at step 269, the method checks if C≦C₂. If so, at step 272, the method computes U(C)=U_{J}(C)−U_{J}(C₁)+U₁(C₁). If not, at step 275, the method computes U(C)=U₂(C)−U₂(C₂)+U(C₂).

Having constructed a utility function U containing a single joining region, it is also possible to approximate an arbitrary curve in U′ space by forming a utility function U as an arbitrary piecewise sequence of any number of joining regions using known spline construction techniques.

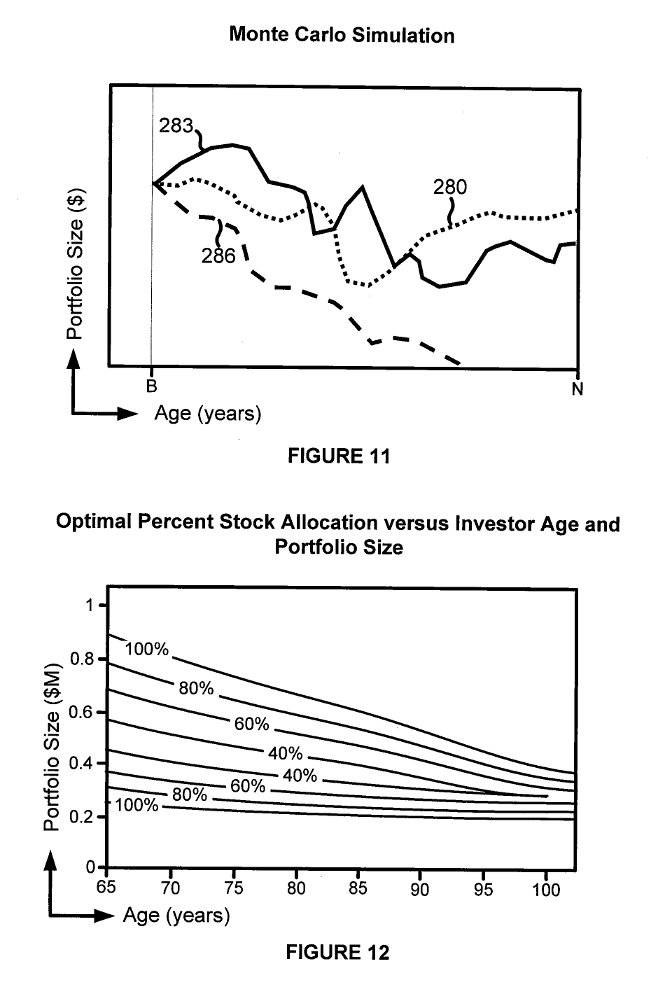

FIG. 11 illustrates a Monte Carlo simulation of the portfolio size as a function of investor's age. The analysis here involves two distinct procedures. First, SDP is used to compute asset allocation/consumption maps as a function of age and portfolio size. An “asset allocation/consumption map” is derived using SDP by working backwards from the terminal age. The “map” displays the asset allocation and consumption amounts for each age and portfolio size. Second, Monte Carlo simulations are run to see how well a particular asset allocation/consumption map performs using returns sequences derived from the historical record. The Monte Carlo simulation rebalances annually to the target asset allocation, and withdrawals are taken at the start of the year. No transaction costs are assumed for rebalancing, sales, or purchases. All calculations and results are in real, inflation-adjusted terms. In an embodiment, the simulation starts at investor age B and follows randomly drawn paths 280, 283, and 286, which illustrate thousands of computed paths. The same code base is used for performing both simulation and SDP. Where SDP performs a single forward time-step, an enclosing loop is used in the case of simulation to perform multiple time steps, until the upper bound on age is reached.

SDP is so good at finding the optimal solution that it can cause a false sense of confidence when run on the same data set as to be used for simulation. Even if the returns distribution is the same in the past as the future there is the issue that the past and the future are separate samples from this distribution and will have their own sample statistics such as means and standard deviations. I would like to simulate SDP on out-of-sample data, but there is a paucity of data.

The solution I use isn't perfect, but it works. In an embodiment, the computer performs SDP on the adjusted historical periodic returns. In an alternative embodiment, the computer performs SDP on sample returns generated from summary statistics. Simulation is more complex and involves computing the sample statistics for the adjusted historical record, generating a prototype returns sequence from those statistics, computing the prototype sequence summary statistics for the prototype sequence, generating a sample return from the prototype summary statistics, and using that sample return for simulation. Relevant summary statistics are means, standard deviations, and correlations between asset classes. Time based correlations are not respected. As a performance optimization a single Cholesky decomposition is used to drive the correlations. This is not found to alter the results appreciably. The Cholesky generator outputs returns that are normally distributed and respect the prototype mean and standard deviation. This is projected onto a log normal distribution because respecting the geometric mean is important in financial applications.

The two stage approach to generating a sample is necessary because it is likely that the historical record does not reflect the population from which it was selected. A two stage process allows us to generate a returns sequence that is consistently bad or good, reflecting the possibility that the adjusted historical record was an anomaly. Experimentation shows that without a two stage sample generation process the results appear 2-5% higher than they actually are.

In an embodiment, the starting point in establishing stock and bond market data to use in the asset allocator and simulator are returns provided by Shiller, Irrational Exuberance (2005), which is incorporated by reference herein. They are for U.S. large cap stocks and constant maturity 10-year U.S. Treasury notes for the period 1927-2013. Stock market returns are adjusted to include dividends, and bond market returns are adjusted to include changes in market price.

In an embodiment, the invention seeks to model not 10 year Treasuries, but bonds indicative of the U.S. investment grade bond universe. This is done by increasing the geometric mean real return of 10 year Treasuries by 0.7% and the volatility by 10%.

Pfau, Choosing a retirement income strategy: a new evaluation framework (2012), which is incorporated by reference, reports that over the period 1900-2010 for a GDP weighted portfolio of 19 developed market countries the equity risk premium relative to long term government bonds had an arithmetic mean value of 4.8%. With geometric mean real 10 year Treasury returns of 2.0% from the data described in Shiller, Irrational Exuberance (2005), this arithmetic equity risk premium can be reproduced by adjusting the equity returns to a 5.2% real geometric mean. The difference in returns between using U.S. Treasury 10 year notes and long term 30 year bonds is insignificant. This adjustment is also intended to reflect the widely held belief that U.S. stock market returns will be lower in the future than in the past as described Hammond Jr. et al., Rethinking the Equity Risk Premium: An Overview and Some New Ideas (2011).

FIGS. 12-21 illustrate the results obtained by the method for a particular embodiment having the following facts and assumptions:
Marital status: male/female couple.
Consumption change on death: no change if a spouse dies.
Age: Both age 65 in 2014.
Status: Retired.
Life span: Stochastic based on Social Security Administration projections. The U.S. Social Security Administration produces period and cohort life tables as described in Bell et al., 2005 Life Tables for the United States Social Security Area 1900-2100, Actuarial Study No. 120, U.S. Social Security Administration, which is incorporated by reference, that report the probability of death by age. The cohort tables are forward looking and build in projected mortality improvements, so these tables are used to project future mortality for a same-age couple. No change in guaranteed lifetime income is assumed to occur upon the death of a single member of the couple. By the same measure consumption utility also doesn't get reduced, perhaps partially offsetting things.
Investment portfolio size: $500,000.
Guaranteed lifetime income: Social Security starting at retirement of $30,000/year inflation adjusted. The average Social Security payment is currently $15,500/year per person.
Required income: $0-$40,000. $40,000 is just slightly below the average income of retired households according to the Bureau of Labor Statistics Consumer Expenditure Surveys.
Desired income: $40,000-$60,000.
Relative risk aversion required spending region: γ=4.0. This represents a moderate degree of risk aversion.
Relative risk aversion extra spending region: γ=1.0. This represents a very low degree of risk aversion.
Utility slope ratio at start of transition region: 0.05. Extra spending is far less valuable than desired spending.
Transition region: cubic polynomial in utility slope space.
Discount rate: 3.0%/year. This is the rate at which present consumption is favored over future consumption. The chosen value is used by Medicare and Social Security Payroll Taxes and Benefits for People in Different Birth Cohorts, Congressional Budget Office (2013), which is incorporated by reference, to discount Social Security payments, and is derived from future projections for long term bonds on the assumption that bonds rates denote a societal expression of the preference for present over future consumption.
Market returns: derived from Shiller historical data 1927-2013.
Real stock market returns: geometric: 5.2%; arithmetic: 7.1%, standard deviation: 19.4%.
Real bond market returns: geometric: 2.7%; arithmetic: 3.1%, standard deviation: 9.1%.
Management expense: 0.1%. This value is relatively low, and assumes a low cost provider such as Vanguard.
Taxes: None.
Bequest motive: None.

FIG. 12 illustrates optimal percent stock allocation vs. investor age and portfolio size. There is a banding pattern running across the asset allocation plot. Taking a vertical slice through the Figure and starting from a portfolio size of zero, we observe with little money γ=4 and the overall asset allocation would be balanced. However the zero risk nature of defined benefit income resembles bonds, and since more than the requisite amount of bonds are present, the actual asset allocation will be 100% stock to compensate. As portfolio increases the asset allocation corresponds to γ=4, and the asset allocation of stocks/bonds becomes 40/60. As the portfolio increases further, γ=1 and the asset allocation becomes 100% stock. Some assume that if an investor has reached his or her financial objective it is time to become more conservative, because there isn't any point in taking the risk in investing in stocks. FIG. 12 show that this assumption is false. The lower degree of risk aversion at high consumption levels means the investor can afford to take a higher degree of risk on stocks.

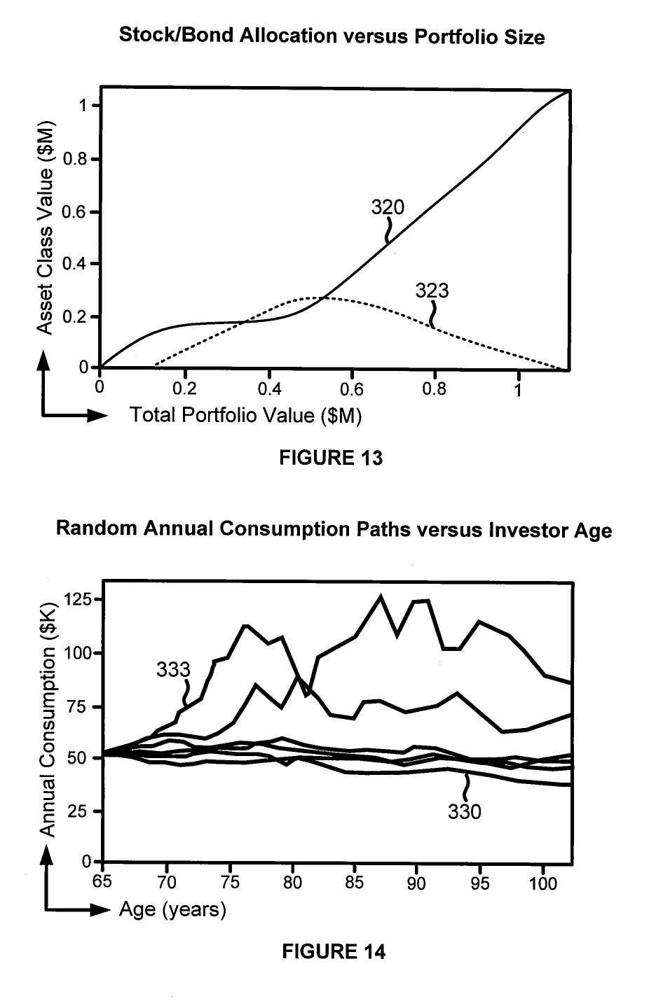

FIG. 13 illustrates stock/bond allocation vs. portfolio size at a particular investor age. When we consider the absolute value of assets in stocks (e.g. curve 320), there is almost a plateau when the portfolio is from $0.2M to $0.4M, and in bonds (e.g. curve 323) a hill centered at about $0.5M. At first new assets are allocated exclusively to stocks, but then things slow, and we almost plateau with few new assets allocated to stocks. Then more new assets are allocated to stocks, until eventually even old assets get reallocated to stocks. At first there are no bond holdings until portfolio size is about $0.1M, then bonds ramp up, reach a peak at about $0.5M, and then decline to zero when the portfolio size increases above $1M. The bond hill functions as a buffer that attempts to stop consumption dipping into the required space. Beyond the crest of the hill the method indicates it is advantageous to invest heavily in stocks, because the bond buffer will re-emerge if needed and can be fallen back on should thing turn out poorly.

Before the top of the hill asset allocation is balanced or stock heavy in accordance with the dictates of the required spending region utility function and guaranteed lifetime income.

FIG. 14 illustrates consumption paths vs. investor age obtained by Monte Carlo simulation. Annual consumption shows considerable upside variability (e.g., curve 333) but little downside variation (e.g., curve 330). This is consistent with the investor taking risk only when they can afford to do so.

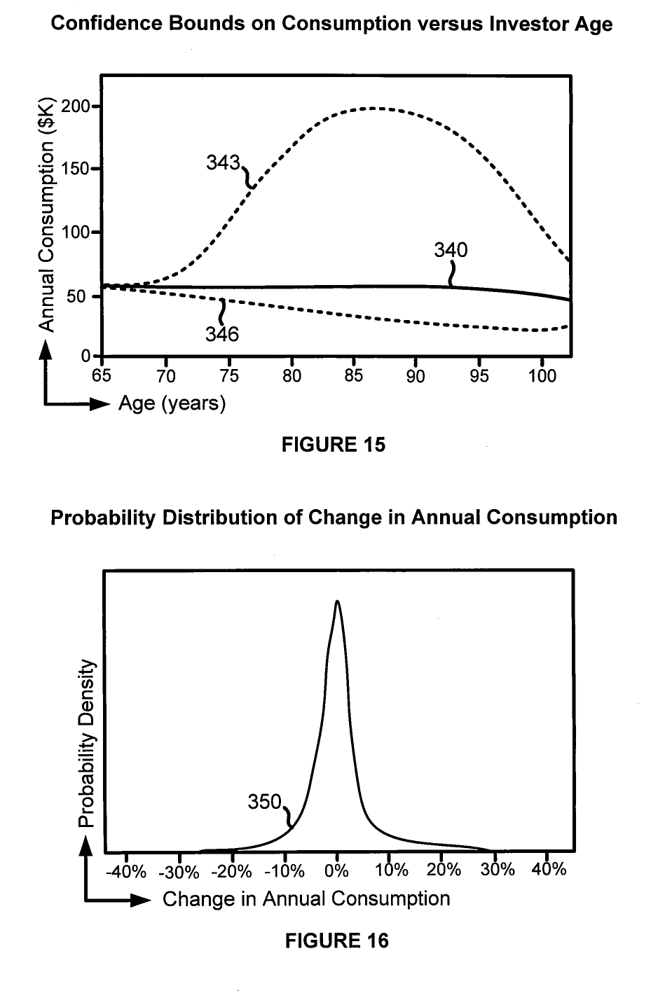

FIG. 15 illustrates confidence bounds on consumption vs. investor age. FIG. 15 shows the median (e.g., curve 340), the 2.5th percentile (e.g., curve 346), and 97.5th percentile (e.g., curve 343) distribution of consumption as a function of an investor's age. Once again there a solid floor with considerable upside potential.

FIG. 16 illustrates probability distribution of change in annual consumption. The probability of a change in consumption is illustrated (e.g., curve 350). A change in consumption of less than −5% is rare.

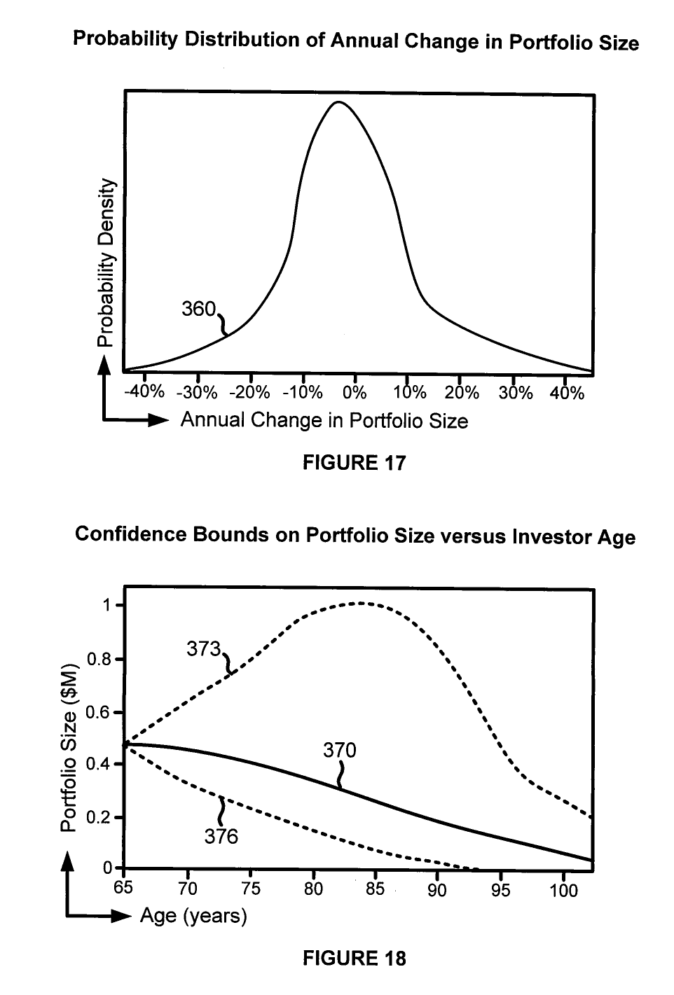

FIG. 17 illustrates probability distribution of annual change in portfolio size. FIGS. 16-17 indicate that the portfolio size can vary substantially while consumption varies less.

FIG. 18 illustrates confidence bounds on portfolio size vs. investor age. FIG. 18 shows the median (e.g., curve 370), the 2.5th percentile (e.g., curve 376), and 97.5th percentile (e.g., curve 373) distribution of portfolio size as a function of an investor's age. SDP isn't leaving money on the table, but gradually decreasing the size of the portfolio as the couple ages.

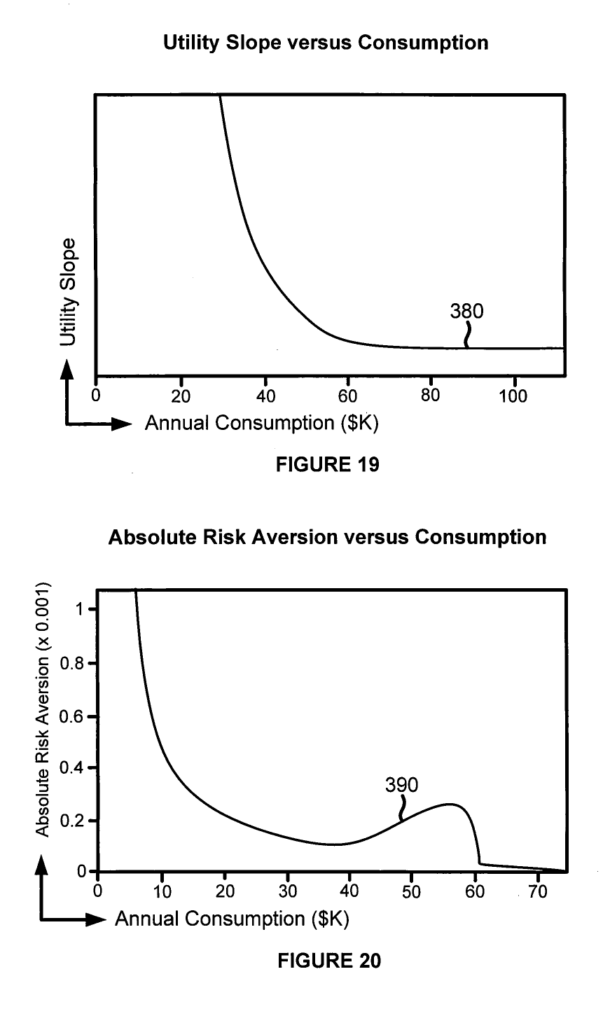

FIG. 19 illustrates a utility slope vs. consumption curve. There is a nice smooth curve in U′ space (e.g., curve 380).

FIG. 20 illustrates an absolute risk aversion vs. consumption. Absolute risk aversion (ARA) is defined as −U″/U′. As shown, there is an anomaly in ARA space as illustrated by curve 390 from $40K-$60K. This may be unavoidable. For the transition region the method prefers to specify U and U′ at the start of the transition region, U′ at the end of the transition region, and either U″ or ARA at the start and end of the transition region. That is five constraints. A polynomial with five terms is likely to be non-monotone. Using a spline would have the same problem. Once U′ is fully specified, U″ and ARA are determined. Getting a smooth curve in U′ space is preferred since the slope of the utility function determines the incremental value of a dollar of consumption.

In an embodiment, SDP provides a framework for making asset allocation and consumption decisions. One of the concerns about the consumption outcomes for the default portfolio is that upside consumption is back-loaded. The return on stocks after expenses is 5.1%, while the discount rate is 3.0%, so it makes sense to defer upside consumption until the risk of dying becomes too large. Many retirees might prefer to make upside consumption expenditures earlier, so long as it doesn't significantly impact the risk of suffering later. This can be readily achieved by specifying a discount rate for upside consumption that is different and higher than that for floor consumption. Preferably, the method doesn't increase the discount rate for floor consumption, because that would mean caring less about well-being at old ages.

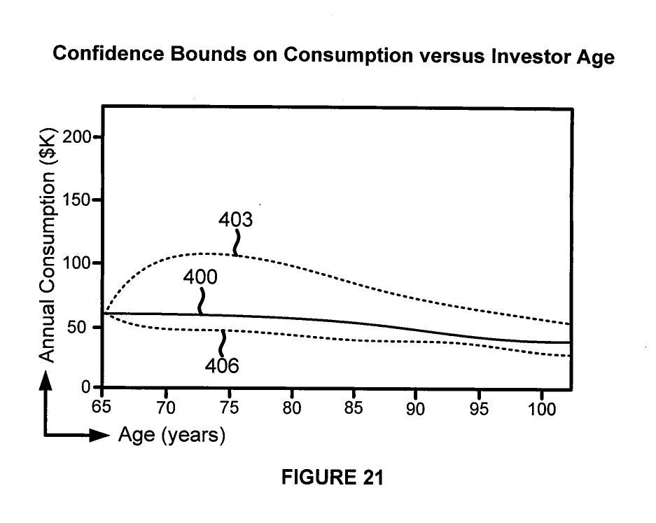

FIG. 21 illustrates a confidence bounds on consumption vs. investor age for an upside discount rate of 15%. FIG. 21 shows the median (e.g., curve 400), the 2.5th percentile (e.g., curve 406), and 97.5th percentile (e.g., curve 403) distribution of consumption as a function of an investor's age. Consumption may grow more rapidly, and gradually decline. Until very old ages consumption typically stays at or above the floor level.

What is claimed:

1. A method in a computer including processor(s) coupled to a memory, comprising:
inputting data representing consumption level(s) into the memory, wherein a value of the consumption level(s) represents required consumption C₁;
inputting data representing returns of each asset class into the memory;
performing one or more step(s) of stochastic dynamic programming (SDP) in the processor(s) using the data representing the returns of each asset class and values of a utility function U based on the consumption levels to compute values of aggregate utility of wealth, wherein the SDP step(s) includes the following sub-steps:
reading data representing an aggregate utility of wealth Uₜ₊₁ for wealth levels W_{t+1,1} through W_{t+1,M}, and a description of single time period utility U;
computing local searches in the processor(s) an optimal asset allocation vector Aₜ, an optimal consumption Cₜ, and an optimal aggregate utility of wealth Uₜ for a wealth level W_{t,1};
computing local searches in the processor(s) the optimal asset allocation vector Aₜ, the optimal consumption Cₜ, and the optimal aggregate utility of wealth Uₜ for a wealth level W_{t,2};
computing local searches in the processor(s) the optimal asset allocation vector Aₜ, the optimal consumption Cₜ, and the optimal aggregate utility of wealth Uₜ for additional wealth levels up to at least wealth level W_{t,M};
storing the values of the aggregate utility of wealth Uₜ for wealth levels W_{t,1} through W_{t,M} in the memory; and
outputting the optimal asset allocation vector A_{B} and the optimal consumption C_{B} at an initial age B and wealth W_{B}.

2. The method of claim 1, wherein another value of the consumption level(s) represents extra consumption C₂.

3. The method of claim 1, wherein the utility function U includes a required consumption region and an extra consumption region.

4. The method of claim 3, wherein the utility function U further includes a desired consumption region.

5. The method of claim 4, wherein U in the desired consumption region is a polynomial of the fourth power U_{J}, wherein U_{J} joins the utility function U₁ in the required consumption region and utility function U₂ in the extra consumption region, the first derivatives of U₁ and U₂ to U_{J}′, and the second derivatives of U₁ and U₂ to U_{J}″.

6. The method of claim 4, wherein U in the desired consumption region equals U_{J}, wherein U_{J} is defined by the following equations:
U_{J}′(C)=wC³+xC²+yC+z
U_{J}′(C₁)=U₁′(C₁)
U_{J}′(C₂)=U₂′(C₂)
U_{J}″(C₁)=U₁″(C₁)
U_{J}″(C₂)=U₂″(C₂).

7. The method of claim 2, wherein utility function U includes utility functions U₁ and U₂ joined by U_{J}, wherein U is defined by the following equations:
U(C)=U₁(C) for C≦C₁
U(C)=U_{J}(C)−U_{J}(C₁)+U₁(C₁) for C₁<C≦C₂
U(C)=U₂(C)−U₂(C₂)+U(C₂) for C₂<C.

8. The method of claim 1, wherein the stochastic dynamic programming includes computing Uₜ(Wₜ)=Tₜ(Wₜ, Rₜ₊₁⁻¹(Eₜ[Rₜ₊₁(Uₜ₊₁(Wₜ₊₁))])), wherein Uₜ(Wₜ) represents the utility of wealth at time t, Tₜ is the time aggregator, Wₜ is wealth at time t, Rₜ₊₁ is the risk aggregator, and Eₜ is the expected value operator.

9. The method of claim 1, wherein the stochastic dynamic programming step includes computing Uₜ(Wₜ)=aₜU(Cₜ(Wₜ))/(1+r)^{t}+Eₜ[Uₜ₊₁(Wₜ₊₁)], wherein Uₜ(Wₜ) represents the utility of wealth Wₜ at time t, aₜ represents the probability of an entity being alive at time t, U(Cₜ(Wₜ)) represents the single time period utility of consumption Cₜ(Wₜ), r represents the discount rate, Cₜ(Wₜ) is the consumption amount for wealth Wₜ at time t, and Eₜ is the expectation operator at time t.

10. The method of claim 1, further comprising inputting data into the memory that represents the probability of an entity being alive in the future and further performing stochastic dynamic programming to compute an asset allocation and a consumption based on the probability of the entity being alive.

11. The method of claim 1, further comprising inputting data representing the correlations of each asset class and performing stochastic dynamic programming to compute the asset allocation and the consumption based on the correlations.

12. The method of claim 1, wherein the data representing the returns is based on periodic returns or summary statistics.

13. The method of claim 1, further comprising inputting data into the memory that represents discount rates to adjust the utility function U.

14. The method of claim 13, wherein the discount rates represent the floor and/or upside utility discount rates.

15. The method of claim 14, wherein the range of the floor utility discount rate does not match a required consumption region.

16. A non-transitory computer-readable medium storing program instructions that cause a computer to perform the following steps, comprising:
inputting data representing consumption level(s) into the memory, wherein a value of the consumption level(s) represents required consumption C₁;
inputting data representing returns of each asset class into the memory;
performing one or more step(s) of stochastic dynamic programming in the processor(s) using the data representing the returns of each asset class and values of a utility function U based on the consumption levels to compute values of aggregate utility of wealth;
storing the values of the aggregate utility of wealth in the memory;
computing local searches in the processor(s) of the values of aggregate utility of wealth over an asset allocation and consumption space to compute optimal asset allocation and optimal consumption; and
outputting the optimal asset allocation and the optimal consumption value for an initial age and wealth.

17. The non-transitory computer-readable medium of claim 16, wherein the utility function U includes a required consumption region and an extra consumption region.

18. The non-transitory computer-readable medium of claim 17, wherein the utility function U includes a desired consumption region.

19. The non-transitory computer-readable medium of claim 16, wherein the stochastic dynamic programming step includes computing Uₜ(Wₜ)=aₜU(Cₜ(Wₜ))/(1+r)^{t}+Eₜ[Uₜ₊₁(Wₜ₊₁)], wherein Uₜ(Wₜ) represents the utility of wealth Wₜ at time t, aₜ represents the probability of an entity being alive at time t, U(Cₜ(Wₜ)) represents the single time period utility of consumption Cₜ(Wₜ), r represents the discount rate, Cₜ(Wₜ) is the consumption amount for wealth Wₜ at time t, and Eₜ is the expectation operator at time t.

20. The non-transitory computer-readable medium of claim 16, further comprising inputting data representing the probability of an entity being alive in the future into the memory and further performing stochastic dynamic programming to compute an asset allocation and a consumption based on the probability of the entity being alive.

21. The non-transitory computer-readable medium of claim 16, further comprising inputting data representing discount rates to adjust the utility function U into the memory.
